(19) United States
(12) Patent Application Publication
(10) Pub. No.: US 2011/0282695 A1
(43) Pub. Date: Nov. 17, 2011

(54) METHODS AND SYSTEMS FOR FRAUD DETECTION

(76) Inventor: Joseph Blue, St. Paul, MN (US)

(21) Appl. No.: 13/108,696

(22) Filed: May 16, 2011

Related U.S. Application Data
(60) Provisional application No. 61/345,370, filed on May 17, 2010.

(51) Int. Cl. G06Q 40/00

(52) U.S. Cl. 705/4

(57) ABSTRACT

System and methods for detecting healthcare claim fraud and abuse are provided. In one embodiment, the system includes a combination of supervised method and a unsupervised method as well as with a responsiveness analysis.

### CROSS-REFERENCE TO RELATED APPLICATIONS

This application claims priority to U.S. Provisional Application No. 61/345,370, the entire contents of which are specifically incorporated herein by reference without disclaimer.

### BACKGROUND OF THE INVENTION

1. Field of the Invention

This invention relates to health related data analysis and more particularly relates to a system and method for fraud detection for health services.

2. Description of the Related Art

According to the Center for Medicare and Medicaid Services (CMS—formerly the Health Care Financing Administration (HCFA)), annual health care expenditures in the United States totaled over $1.4 trillion dollars in 2001, and are expected to increase 6.5% a year. Of this amount, a significant percentage is paid on fraudulent or abusive claims, though the amount lost to health care fraud and abuse can never be quantified to the dollar. In May 1992, U.S. General Accounting Office (GAO) reported that the loss amounted to as much as 10% of the nation's total annual health care expenditure, approximately $84 billion. A July 1997 audit of annual Medicare payments by the Inspector General found that approximately 14 percent of Medicare payments (about $23.2 billion) made in fiscal year 1996 was improperly paid, due to fraud, abuse, and the lack of medical documentation to support claims. Many private insurers estimate the proportion of health care dollars lost to fraud to be in the range of 3-5%, which amounts to roughly $30-$50 billion, annually. It is widely accepted that losses due to fraud and abuse are an enormous drain on both the public and private healthcare systems.

Health insurance companies typically maintain databases of health insurance claim information, geographic information, demographic information, and other data about health insurance plan members. Unfortunately, typical methods for analyzing such data and detecting fraud are often cumbersome, pricely, and require unworkably high processing times and resources.

### SUMMARY OF THE INVENTION

A system is presented for detecting healthcare claim fraud and abuse. In one embodiment, the system includes a data storage device configured to store a database comprising one or more claims or records. The system may also include a server in data communication with the data storage device. The server may be suitably programmed to detect anomalous claims from a first group of insurance claims; request records associated with the anomalous claims from service providers; classify the anomalous claims into responsive claims and non-responsive claims based on responsiveness of the service providers to the request, wherein fraudulent and non-fraudulent claims are identified from the responsive claims; and generate a fraud model comprising a plurality of fraudulent pattern detectors based on the identified fraudulent and non-fraudulent claims.

In a certain embodiment, the server may further comprise generating a response model based on the classifying of responsive claims and non-responsive claims. In a further embodiment, the server may further comprise creating a supervised model for detecting fraud based on the response model and the fraud model.

In an additional embodiment, the server may further comprise assigning weight to a plurality of fraudulent pattern detectors. The server may further comprise selecting fraudulent pattern detectors, wherein the assigned weights of the selected fraudulent pattern detectors satisfy a predetermined criterion.

In certain embodiments, the server may repeat the process for more sets of claims, such as using fraudulent pattern detectors to detect anomalous claims from a second group of claims or repeat one or more of the step describe above. For fraud prediction, the server may further comprise predicting the probability of fraud of at least a service provider, at least a service category or at least a claim.

A method is also presented for detecting healthcare claim fraud and abuse. In one embodiment, the method includes: detecting anomalous claims from a first group of insurance claims; requesting records associated with the anomalous claims from service providers; classifying the anomalous claims into responsive claims and non-responsive claims based on responsiveness of the service providers to the request, wherein fraudulent and non-fraudulent claims are identified from the responsive claims; and generating a fraud model comprising a plurality of fraudulent pattern detectors based on the identified fraudulent and non-fraudulent claims. The method in the disclosed embodiments substantially includes the steps necessary to carry out the functions presented above with respect to the operation of the system of the present invention.

The method may further comprise generating a response model based on the classifying of responsive claims and non-responsive claims. In a further embodiment, the method may further comprise creating a supervised model for detecting fraud based on the response model and the fraud model.

In a further embodiment, the method may further comprise assigning weight to a plurality of fraudulent pattern detectors. The method may further comprise selecting fraudulent pattern detectors, wherein the assigned weights of the selected fraudulent pattern detectors satisfy a predetermined criterion.

Certain embodiments of the method may repeat the process for more sets of claims, such as using fraudulent pattern detectors to detect anomalous claims from a second group of claims. For fraud prediction, the method may further comprise predicting the probability of fraud of at least a service provider, at least a service category or at least a claim.

There may be also provided a tangible computer program product comprising a computer readable medium having computer usable program code executable to perform operations comprising: detecting anomalous claims from a first group of insurance claims; requesting records associated with the anomalous claims from service providers; classifying the anomalous claims into responsive claims and non-responsive claims based on responsiveness of the service providers to the request, wherein fraudulent and non-fraudulent claims are identified from the responsive claims; and generating a fraud model comprising a plurality of fraudulent pattern detectors based on the identified fraudulent and non-fraudulent claims.

In an additional embodiment, the operations may further comprise generating a response model based on the classifying of responsive claims and non-responsive claims. In a further embodiment, the operations may further comprise creating a supervised model for detecting fraud based on the response model and the fraud model.

In certain embodiments, the operations may further comprise assigning weight to a plurality of fraudulent pattern detectors. The operations may further comprise selecting fraudulent pattern detectors, wherein the assigned weights of the selected fraudulent pattern detectors satisfy a predetermined criterion.

In a further embodiment, the operations may repeat the process for more sets of claims, such as using fraudulent pattern detectors to detect anomalous claims from a second group of claims. For fraud prediction, the operations may further comprise predicting the probability of fraud of at least a service provider, at least a service category or at least a claim.

For a temporal analysis, the operations may further comprise selecting the group of claims or records from within a predetermined time frame.

The term “associated” is referred to as connected or related. The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for detecting healthcare claim fraud and abuse;

FIG. 2 is a schematic block diagram illustrating one embodiment of a database system for detecting healthcare claim fraud and abuse;

FIG. 3 is a schematic block diagram illustrating one embodiment of a computer system that may be used in accordance with certain embodiments of the system for detecting healthcare claim fraud and abuse;

FIG. 4 is a schematic logical diagram illustrating one embodiment of abstraction layers of operation in a system for detecting healthcare claim fraud and abuse;

FIG. 5 is a schematic block diagram illustrating one embodiment of a system for detecting healthcare claim fraud and abuse;

FIG. 6 is a schematic block diagram illustrating one embodiment of a system for detecting healthcare claim fraud and abuse;

FIG. 7 is a schematic flowchart diagram illustrating one embodiment of a method for detecting healthcare claim fraud and abuse;

FIG. 8 is a schematic flowchart diagram illustrating one embodiment of a method for detecting healthcare claim fraud and abuse;

FIG. 9 is a schematic diagram illustrating one embodiment of a method for detecting healthcare claim fraud and abuse;

FIG. 10 is a schematic diagram illustrating one embodiment of a method for detecting healthcare claim fraud and abuse.

FIG. 11 is a schematic diagram illustrating one embodiment of a method for detecting healthcare claim fraud and abuse.

### DETAILED DESCRIPTION

The universe of healthcare claims available for analysis and the possible outcomes in terms of savings and recoveries are enormous. Predictive modeling analytics can be applied to the entire universe or any subset. In certain aspects, the present invention discloses methods, systems and program products related to detecting healthcare claim fraud and abuse by deriving and updating a supervised model with analysis derived from unsupervised anomaly detection. There are two primary categories of predictive models: supervised and unsupervised. A supervised model provides superior fraud detection over unsupervised methods. However, in healthcare claims most fraud goes unreported and undetected, making supervised models infeasible.

In an unsupervised approach, the outcome variable, for instance whether an uninvestigated healthcare claim is fraudulent or not, is generally unknown when building the model. Therefore, the modeling effort is mainly focused on explaining or predicting the distributions or patterns in the input data space. For example, clustering analysis can be used to combine customers or their activities into groups that have certain common characteristics. Anomaly detection is another example. Data are assumed to exhibit a set of known patterns and any deviation from these can be statistically detected. In its simple form this is also known as outlier detection. Identifying combinations of statistical outliers based on domain knowledge can lead to anomalous patterns that are usually very good predictors of fraud and abuse.

In a supervised modeling approach, the outcome variable is generally known when building the model. The predictive modeling effort is therefore focused on constructing the relationships between input data patterns and the outcome variable. A number of linear and nonlinear optimization techniques can then be applied to create the most effective model for predicting future outcomes based on known input variables. While both approaches can be useful, when only a limited number of known outcomes exist in the claims, the inventor hereof has recognized that the unsupervised model may yield superior results.

Unsupervised models focus on outliers, and it becomes critical to get the reference frame right. Otherwise, serious distortions may cause too many false positives. For healthcare utilization patterns, the predominant peer references are for providers or patients. Patient peer groups based on demographics usually work best. And provider peer groups are commonly based on specialties and/or on facility types (such as hospital lists, ER, SNFs, etc.). Unfortunately, being self-declared, the provider assigned specialty often proves misleading. Many different techniques are available to improve this somewhat unreliable provider peer definition.

Using the system described by certain aspects of the invention, the inventor converts the results of an unsupervised model into a supervised model and establish a pattern that can be used to conduct a methodical assessment of new fraud patterns over a period of many years. Certain aspects of the invention create a symbiosis in which unsupervised models are continually used to evaluate new patterns and supervised models are used to enhanced detection abilities.

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a component of a machine, a machine or a plurality of machines that are suitably programmed to operate according to executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, a controller, or the like.

Modules may also include software-defined units or instructions that, when executed by a processing machine or device, retrieve and transform data stored on a data storage device from a first state to a second state. An identified module of executable code may, for instance, comprise one or more physical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

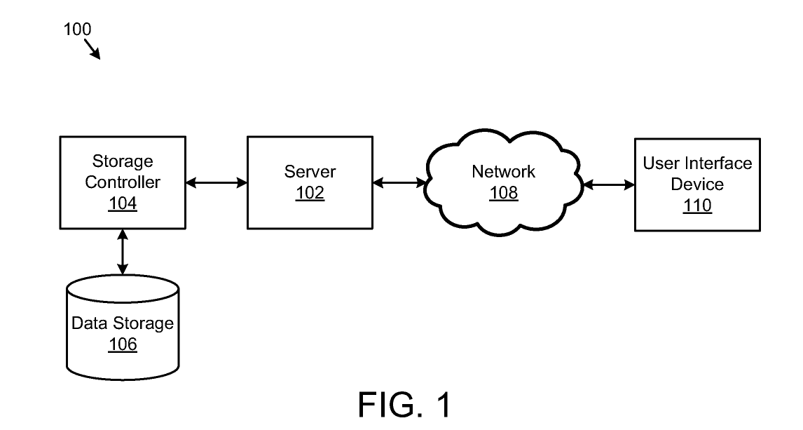

FIG. 1 illustrates one embodiment of a system 100 for detecting healthcare claim fraud and abuse. The system 100 may include a server 102, a data storage device 106, a network 108, and a user interface device 110. In a further embodiment, the system 100 may include a storage controller 104, or storage server, configured to manage data communications between the data storage device 106, and the server 102 or other components in communication with the network 108. In an alternative embodiment, the storage controller 104 may be coupled to the network 108. In a general embodiment, the system 100 may detect anomalous claims, request records associated with anomalous claims, store databases comprising records, identify fraud claims, and generate various models associated with fraud detection. Specifically, the system 100 may generate a response model based on responsiveness of the record requests, generate a fraud model based on the identification of fraudulent claims, and create a supervised model based on the response model and the fraud model.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter predetermined criteria for selection of anomalous claims, a predetermined time frame, or a baseline time for generating an output, fraudulent pattern descriptors, such as a weighted fraudulent pattern descriptor, or the like.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is suitably programmed to detect anomalous claims from a group of insurance claims, request records associated with the anomalous claims from service providers and classifying the anomalous claims into responsive claims and non-responsive claims based on responsiveness of the service providers to the requests, identify fraudulent claims and non-fraudulent claims from the responsive claims, and generate a fraud model comprising a plurality of fraudulent pattern descriptors based on the classifying of responsive claims and non-responsive claims. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store health related data, such as insurance claims data, consumer data, or the like. The data may be arranged in a database and accessible through Structured Query Language (SQL) queries, or other data base query languages or operations.

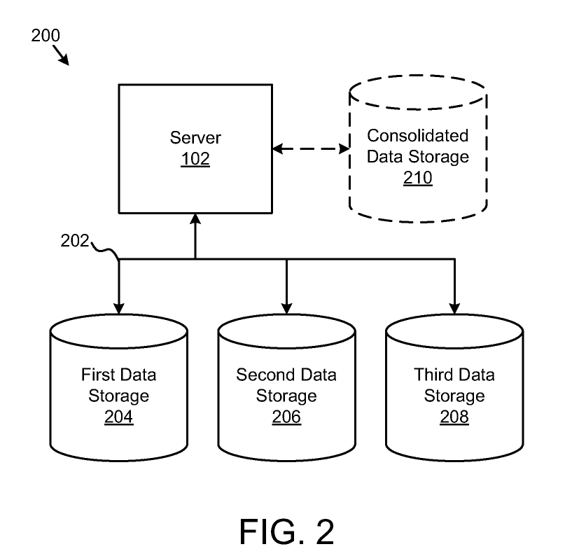

FIG. 2 illustrates one embodiment of a data management system 200 configured to store and manage data for detecting healthcare claim fraud and abuse. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of healthcare claim data, lab data, physical test data, disease progression data, demographic data, geographic data, socioeconomic data, administrative data, clinical data, or the like. The customer information in each database may be keyed to a common field or identifier, such as a subject's name, social security number, customer number, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements for a service, a provider, or a group of services or providers. The server 102 may store the consolidated data set in a consolidated data storage device 210. In such an embodiment, the server 102 may refer back to the consolidated data storage device 210 to obtain a set of data elements associated with a specified service or provider, or a service or provider group. Alternatively, the server 102 may query each of the data storage devices 204-208 independently or in a distributed query to obtain the set of data elements associated with a specified service or provider, or a service or provider group. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, the server 102 may communicate indirectly with the data storage devices 204-210; the server may first communicate with a storage server or storage controller 104.

In one example of the system 200, the first data storage device 204 may store data associated with clinical data that may be comprised in insurance claims. The clinical data may include data associated with medical services, procedures, and prescriptions utilized by the subjects. In one embodiment, the second data storage device 206 may store diagnosis data associated with the subject. The diagnosis data may include one or more diagnoses of conditions. The third data storage device 208 may store fraud-related data. For example, the third data storage device 208 may include data associated with the previously identified fraudulent claims or records. A fourth data storage device (not shown) may store demographic data. For example, the demographic data may include information relating to patient or provider demographics such as gender, race or ethnicity, age, income, disabilities, mobility, educational attainment, home ownership, employment status, location, or the like.

The server 102 may host a software application configured for detecting healthcare claim fraud and abuse. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

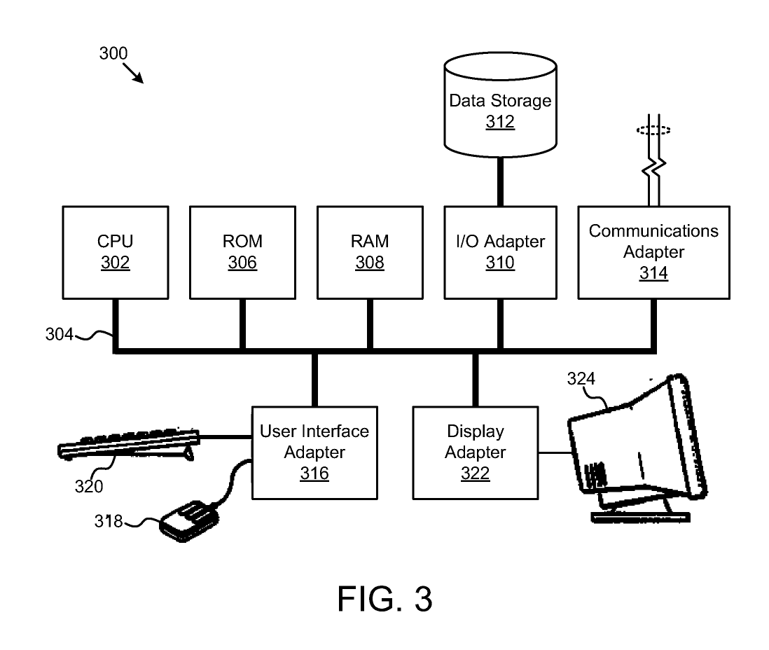

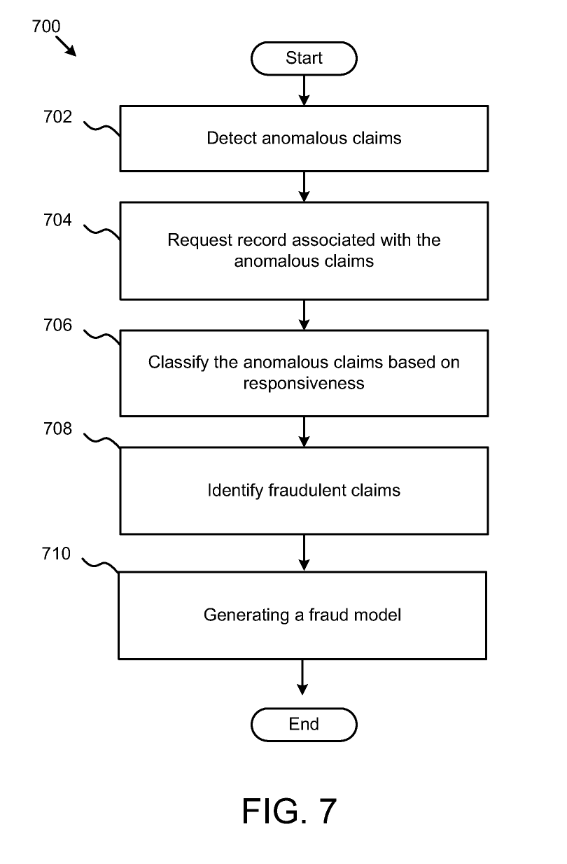

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU, a processor, or a microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIGS. 7-11.

The computer system 300 also may include Random Access Memory (RAM) 308, which may be SRAM, DRAM, SDRAM, or the like. The computer system 300 may utilize RAM 308 to store the various data structures used by a software application suitably programmed for detecting healthcare claim fraud and abuse. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input information for authenticating a user, identifying a specified service or provider, or a service or provider group, receiving claim information, or entering information like a medical code, a test code, a temporal range, a percentile, a limiting criterion, or a selected attribute of a provider. In a further embodiment, the display adapter 322 may display a graphical user interface associated with a software or web-based application for generating an output comprising a graph of relative importance of fraudulent variables, or indices of different time frames.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a LAN and/or WAN, and/or the Internet. The user interface adapter 316 may couple user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

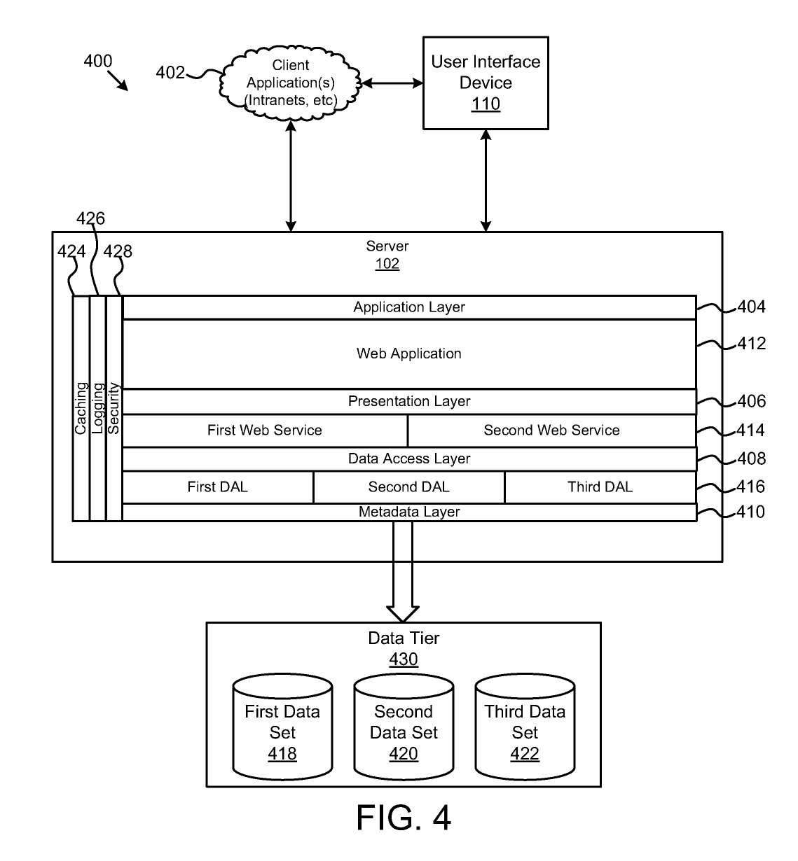

FIG. 4 illustrates one embodiment of a network-based system 400 for detecting healthcare claim fraud and abuse. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprise a data layer or data tier 430. For example, a first data set 418, a second data set 420 and a third data set 422 may comprise a data tier 430 that is stored on one or more data storage devices 204-208.

One or more web applications 412 may operate in the application layer 404. For example, a user may interact with the web application 412 though one or more interfaces 318 and 320 configured to interface with the web application 412 through an I/O adapter 310 that operates on the application layer. In one particular embodiment, a web application 412 may be provided for detecting healthcare claim fraud and abuse that includes software modules configured to perform the steps of detecting anomalous claims from a first group of insurance claims; requesting records associated with the anomalous claims from service providers and classifying the anomalous claims into responsive claims and non-responsive claims based on responsiveness of the service providers to the request; identifying fraudulent and non-fraudulent claims from the responsive claims; and generating a fraud model comprising a plurality of fraudulent pattern detectors based on the identified fraudulent and non-fraudulent claims.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

For example, a web application 412 for analyzing claim data, or other information may access a first web service 414 for detecting anomalous claims of a first group of subjects receiving a first health service and a second web service 414 for detecting anomalous claims of a first group of subjects receiving a second health service. The web services 414 may receive predetermined criteria for selection of health services. In response, the web service 414 may return identified fraud information to generate indices, statistics, distributions, graphs, or the like. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers (DALs) 416 for accessing subject data sets 418-422 in the data tier 430. These subject data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for records associated with anomalous claims.

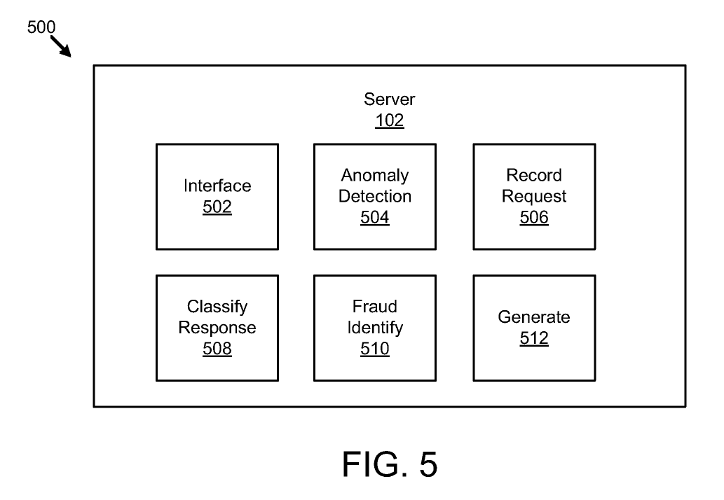

FIG. 5 illustrates a certain embodiment of a system 500 for detecting healthcare claim fraud and abuse. In one embodiment, the system 500 comprises a data storage device 106 and a server 102 configured to load and operate software modules 504-510 configured for detecting healthcare claim fraud and abuse. Alternatively, the system 500 may include hardware modules 504-510 configured with analogue or digital logic, firmware executing FPGAs, or the like configured to detect anomalous claims from a first group of insurance claims; request records associated with the anomalous claims from service providers and classify the anomalous claims into responsive claims and non-responsive claims based on responsiveness of the service providers to the request; identify fraudulent and non-fraudulent claims from the responsive claims; and generate a fraud model comprising a plurality of fraudulent pattern detectors based on the identified fraudulent and non-fraudulent claims. In such embodiments, the system 500 may also include an interface 502, such as an I/O adapter 310, a communication adapter 314, a user interface adapter 316, a display adapter 322, or the like.

In one embodiment, the server 102 may include one or more software defined modules configured to search a dataset 418-422 on a data storage device 204-210 to detect anomalous claims from a first group of insurance claims; request records associated with the anomalous claims from service providers and classify the anomalous claims into responsive claims and non-responsive claims based on responsiveness of the service providers to the request; identify fraudulent and non-fraudulent claims from the responsive claims; and generate a fraud model comprising a plurality of fraudulent pattern detectors based on the identified fraudulent and non-fraudulent claims. In one embodiment, these modules may include an anomaly detection module 504, a record request module 506, a classify response module 508, a fraud identify module 510, and a generation module 512.

Generally, the interface module 502 may receive user inputs and display user outputs. For example, the interface module 502 may receive one or more attributes to identify a group of providers or services. The interface module may further receive one or more predetermined criteria for fraud risk level, health service or provider selection, predetermined time frames, baseline time, and/or other user inputs. In a further embodiment, the interface module 502 may display weighted variables, weights (relative importance), or indices. Such analysis results may include statistics, tables, charts, graphs, recommendations, and the like.

Structurally, the interface module 502 may include one or more of an I/O adapter 310, a communications adapter 314, a user interface adapter 316, and/or a display adapter 322. The interface module 502 may further include I/O ports, pins, pads, wires, busses, and the like for facilitating communications between the CPU 302 and the various adapters and interface components 310-324. The interface module may also include software defined components for interfacing with other software modules on the server 102.

In a specific embodiment, the server 102 may load and execute computer software configured to generate, retrieve, send, or otherwise operate program instructions. For example, the anomaly detection module 504 may communicate an instruction to the data storage device 106, which is configured to detect anomalous claims from a selected set of insurance claim records. A record may comprise a claim comprising price information associated with one or more providers or services. The anomaly detection may also involve a temporal component to aggregate records. If a record has a temporal aspect, the anomaly detection module 504 may obtain multiple records associated with the same provider, but identified by one or more types of services at different time point within a predetermined time frame. Those records may be processed, e.g., averaged, to yield a data value representing the time frame associated with the provider for performing the services. The price information of the records can be the amount assigned for purchasing, the amount paid, the amount billed, the amount used (cost), or the amount allowed. Such records can be in the form of claims or hospital records.

For example, prior to, during or after a patient has received a service, the service provider may transmit to the server 102 appropriate data relating to this service and the data may be stored in the data storage device 106. This data could include a provider code, a provider license number, the proper ICD9 diagnostic code, as well as the proper pre-authorized CPT code. This information could include data relating to the particular individual who conducted the service. A group of this kind of data may be analyzed by the anomaly detection module 504 to determine whether any of the claim data were anomalous.

By way of example, the anomaly detection module 504 may identify a subgroup of anomalous or suspicious claims from a selected set of claim data (for example, a dozen of claims) based on a unsupervised model method. The selected set of claim data may be a group of records for a group of subjects associated with facility fees for a specific service (e.g., CPT, LOINC, ICD9, or NDC code) and/or separately professional fees (e.g., CPT or ICD9 code) for the same codes in a predetermined time frame, preferably, from different providers. The group of subjects may be identified by a set of attributes, such as a predetermined combination of region, age, gender, condition, etc. The condition may be a health state, a specific disease state, or at risk or suspected to have a particular disease (a disease-related state). Cohort matching may be used to identify services that may be associated with a specific disease state or disease-related state. The identified services may then be used to search for records of the services from different providers. Unsupervised methods of statistical detection involve detecting claims that are abnormal among the selected group of claim data. Both claims adjusters and computers can also be trained to identify “red flags,” or symptoms that in the past have often been associated with fraudulent claims. Statistical detection does not prove that claims are fraudulent; it merely identifies suspicious claims that need to be investigated further.

In one embodiment, the record request module 506 may request records associated with the detected anomalous claims from service providers. For example, the records to be requested may include lab reports, diagnostic results, doctor's notes, etc. For example, the records requested from the provider may be needed to justify the procedures performed on the anomalous claims.

In another embodiment, the classify response module 508 may classify the anomalous claims into responsive claims and non-responsive claims based on the responsiveness of the service providers to the request. The claims may be further classified as completely responsive, partially responsive and non-responsive claims. Responsive claims, including completely responsive claims and partially responsive claims, refer to claims that providers thereof respond to the associated record request; non-responsive claims, as used herein, refer to claims that providers thereof fail to respond to the associated record request not due to administrative errors. One novel feature of certain aspects of the present invention is to incorporate the responsiveness into fraud analysis.

In a further embodiment, the fraud identify module 510 may be used to analyze anomalous claims, particularly, non-responsive claims, to determine if actual fraud has taken place to create known examples. In a still further embodiment, the generate module 512 may generate a fraud model based on use of a plurality of variables such as fraudulent patter detectors for the identified fraud claims.

In particular embodiments, the anomaly detection module 504, the record request module 506, the classify response module 508, the fraud identify module 510, or the generation module 512 may include analogue or digital logic, firmware, or software configured to carry out one or more analytic functions according to one or more predefined logic functions. In a further embodiment, the server 102 may include a software defined anomaly detection module 504, record request module 506, classify response module 508, fraud identify module 510, or generation module 512 configured to perform analytic functions of the information and data retrieved from the database for anomaly detection and fraud identification.

In a specific embodiment, the generate module 512 may feed collected data into a spreadsheet configured to perform one or more calculations on the data for predictive modeling. For example an Excel® spreadsheet may include one or more embedded functions or operations configured to calculate statistics such as averages, ratios, counts, summations, and the like. The data may be automatically imported into a spreadsheet using a macro, a software-based script, or the like. In an alternative embodiment, the anomaly detection module 504, the record request module 506, the classify response module 508, the fraud identify module 510, or the generation module 512 may include hard-coded or dynamically variable software functions for calculating such statistics and generating results for a user. In a further embodiment, the generation module 512 may also create outputs such as statistics, tables, charts, graphs, recommendations, and the like, and particularly generate a probabilistic fraud model or response model for summarizing the result of the identified fraud pattern in the selected set of claims. The fraud model may be generated based on supervised methods such as genetic algorithm, neural networks, regression, or decision tree.

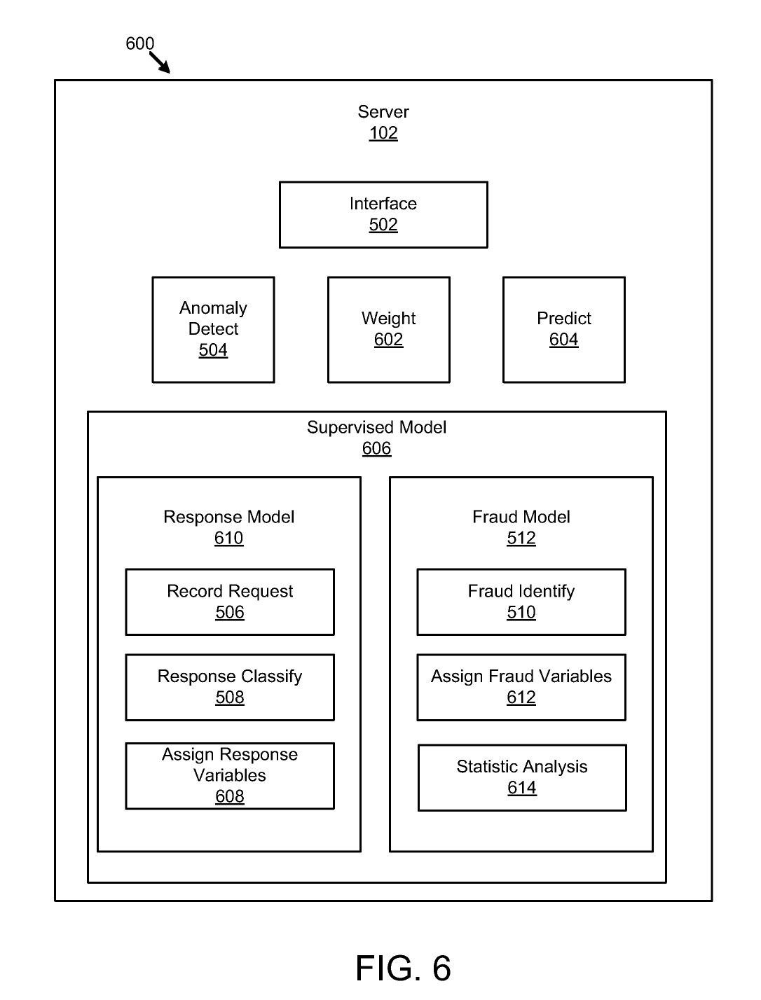

FIG. 6 illustrates a further embodiment of a system 500 for detecting healthcare claim fraud and abuse. The system 500 may include a server 102 as described in FIG. 5. In a further embodiment, the server 102 may include additional software defined modules. For example, the server 102 may include a weight module 602, a predict module 604 or a supervised module 606. In addition, a response model module 610 may include a record request module 506, a response classify module 508, and/or an assign response variable module 608. In a further embodiment, a fraud model module 512 may include a fraud identify module 510, an assign fraud variables module 612, and/or a statistic analysis module 614.

In a certain embodiment, the weight module 602 may assign weights to related variables associated with claims. In a further embodiment, the weight module 602 may select variables with a weight satisfying a predetermined criterion. In certain aspects, weights may be assigned using linear and nonlinear unsupervised methods to identify patterns among the features that appear to be anomalous. For example, a weighted average may be used for the linear approach. In other aspects, an auto-encoder network may be used for the non-linear method, which may involve deconstructing and reconstructing the inputs with the eigenvalues of a principal component analysis.

In an optional embodiment, the predict module 604 may generate a prediction model for a defined service group or provider group based on analysis of fraud and non-responsive claims from the above steps.

Variables are created before their actual contributions are determined and the model training process automatically evaluates, selects, and optimizes the contributions of individual variables based their relationships with known outcomes. In contrast, an unsupervised model used by anomaly detection module 504 employs far fewer variables that are designed to have very clear meanings and measure very specific behavior patterns. In addition, there may be concrete expectations of what the directional contributions will be of each variable to the final score. These and other factors result in more carefully crafted (and often more complex) variables than those used for supervised modeling.

In one embodiment, some exemplary variables are as shown in Table I below.

TABLE I
Exemplary List of Unsupervised Variables

| Variable Name | Description of Pattern | Contexts Used |
|---|---|---|
| Provider Day's worth of | Percent of active days the | Provider History Context, |
| Procedure Time | provider exceeded 8 | Provider Aggregation |
| | hours/day in the last 0-15 | |
| | days, 16-30 days, 31-60 days. | |
| Velocity of Provider's | Change over time for the | Provider History Context, |
| Weekend Activity | proportion of weekend days | Provider Aggregation, |
| | the provider has worked - | Velocity |
| | using the following time | |
| | windows preceding the | |
| | current date of service: 0-30 | |
| | days, 30-60 days, and 60-90 | |
| | days. | |
| Velocity of Provider's Service | Change over time for the rate | Provider History Context, |
| per Patient Ratio | of claim lines per patient, | Provider Aggregation, |
| | across four time intervals | Velocity |
| | relative to the current claim | |
| | processing date: 0-15 days | |
| | prior, 15-30 days prior, 30-45 | |
| | days prior, and 45-60 days | |
| | prior. | |
| Velocity of Provider's | Change over time for the rate | Provider History Context, |
| Modifier | of modifier use, across four | Provider Aggregation, |
| per Procedure Ratio | time intervals relative to the | Velocity |
| | current claim processing date: | |
| | 0-15 days prior, 15-30 days | |
| | prior, 30-45 days prior, and | |
| | 45-60 days prior. | |
| Velocity of Provider's | Change over time for the | Provider History Context, |
| Allowed | amount allowed (total per day) | Provider Aggregation, |
| Amount | according to a fee | Velocity |
| | schedule, across four time | |
| | intervals: 0-15 days prior, 15-30 | |
| | days prior, 30-45 days | |
| | prior, and 45-60 days prior. | |

In a response model module 610, the record request module 506 may request records associated with anomalous claims from associated providers, wherein the anomalous claims are identified by anomaly detection module 504. In a further embodiment, the response classify module 508 may classify the anomalous claims into responsive claims and non-responsive claims based on their responsiveness. In another embodiment, the assign response variables module 608 may use variables such as descriptive assessors to describe various features of responsive claims and non-responsive claims to generate a response model.

In a fraud model module 512, the fraud identify module 510 may identify some of the responsive claims as fraud claims. The assign fraud variables module 612 may assign variables to the fraud claims and identify the relationship between fraud risk and associated variables, for example, using genetic algorithms or any other supervised method, therefore generating a fraud model 512. In addition, the statistic analysis module 614 may perform statistic analysis of the fraud model to yield a plurality of parameters to build early detection probabilistic model for detection of unknown fraud.

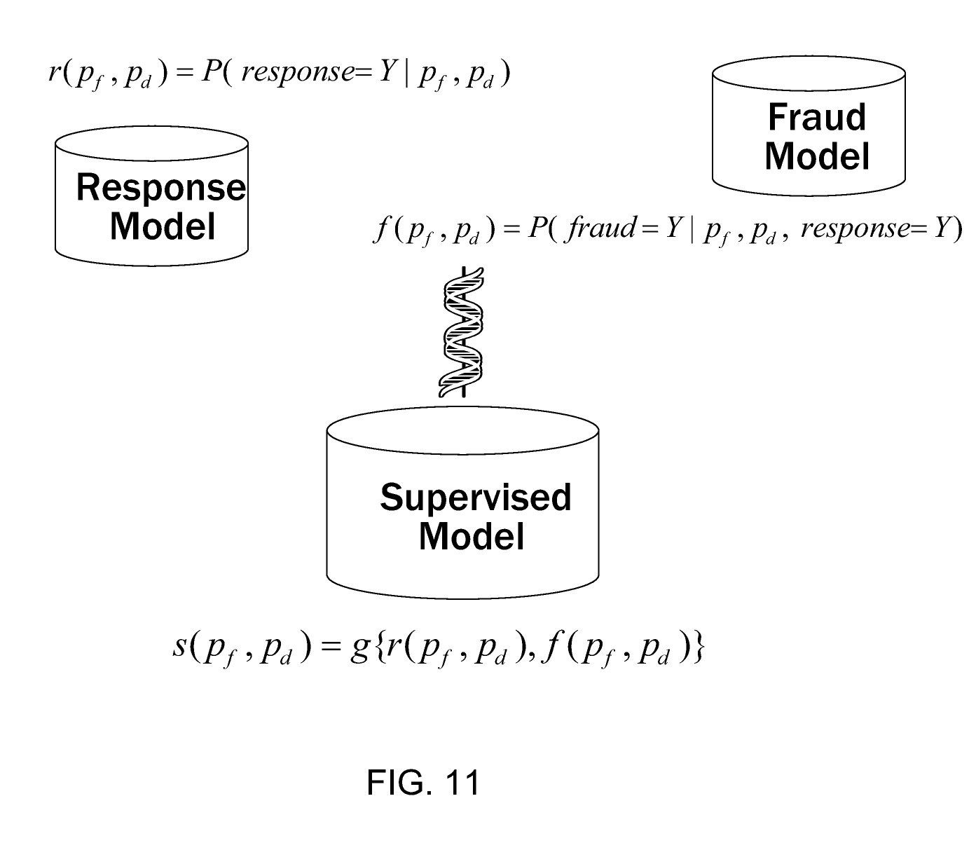

In an additional embodiment, the response model 610 and the fraud model 512 may be combined to create a supervised model 606 as described in FIG. 11.

Although the various functions of the server 102 and the CPU or processor 302 are described in the context of modules, the methods, processes, and software described herein are not limited to a modular structure. Rather, some or all of the functions described in relation to the modules of FIGS. 5-6 may be implemented in various formats including, but not limited to, a single set of integrated instructions, commands, code, queries, etc. In one embodiment, the functions may be implemented in database query instructions, including SQL, PLSQL, or the like. Alternatively, the functions may be implemented in software coded in C, C++, C#, php, Java, or the like. In still another embodiment, the functions may be implemented in web based instructions, including HTML, XML, etc.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 7 illustrates one embodiment of a method 700 for detecting healthcare claim fraud and abuse. In one embodiment, the method 700 starts when the anomaly detection module 504 detects 702 one or more anomalous claims from a defined group of claims. The group of claims may include prices for a health service provided by a group of providers. The method 700 may continue when the server 102 issues a command to request 704 records associated with the anomalous claims using the record request module 506. The server 102 may then issue a command to classify 706 the anomalous claims based on responsiveness of the claims. Further, the server 102 may identify 708 fraudulent claims from the responsive claims based on the requested record or expert opinion. In a still further aspect, the server 102 may generate 710 a fraud model for a defined service or a defined provider or a category thereof.

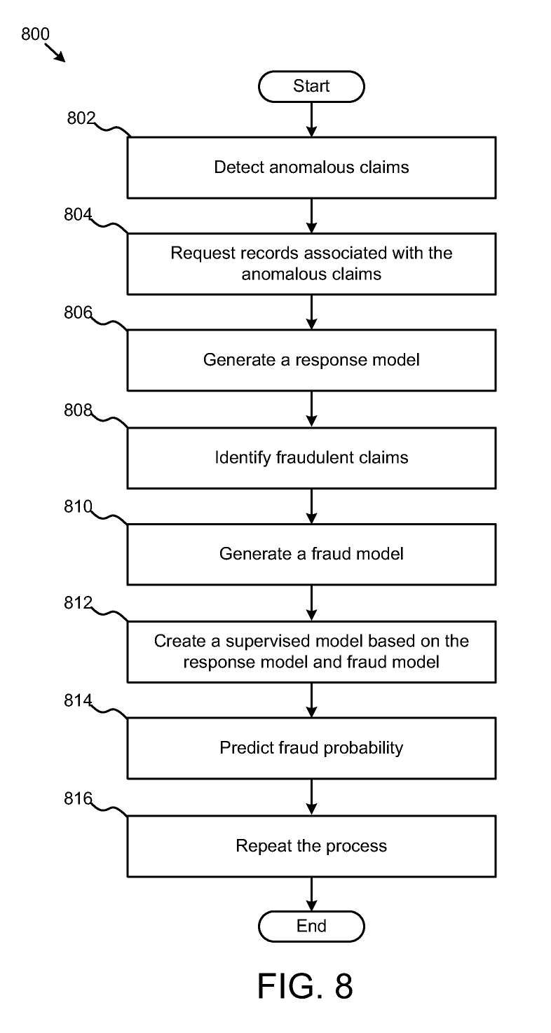

FIG. 8 illustrates another embodiment of a method 800 for detecting healthcare claim fraud and abuse. In one embodiment, the method 800 starts when the anomaly detection module 504 detects 802 one or more anomalous claims from a defined group of claims. The server 102 may then request 804 records associated with the anomalous claims. Based on the responsiveness, the server 102 may classify anomalous claims into responsive claims and non-responsive claims, and model the responsiveness into a response model based on descriptive variables associated thereof. The server 102 may further identify 808 fraudulent claims from responsive claims and generate 810 a fraud model. In a further embodiment, the server 102 may create 812 a supervised model based on the response model and the fraud model. The server 102 may additionally predict 814 future or unknown fraud probability of a defined provider using the components of the above supervised model.

In a still further embodiment, new fraudulent pattern detectors may be used to create a new anomaly detection system and a new fraud model, as one or more steps of the above process may repeat 816.

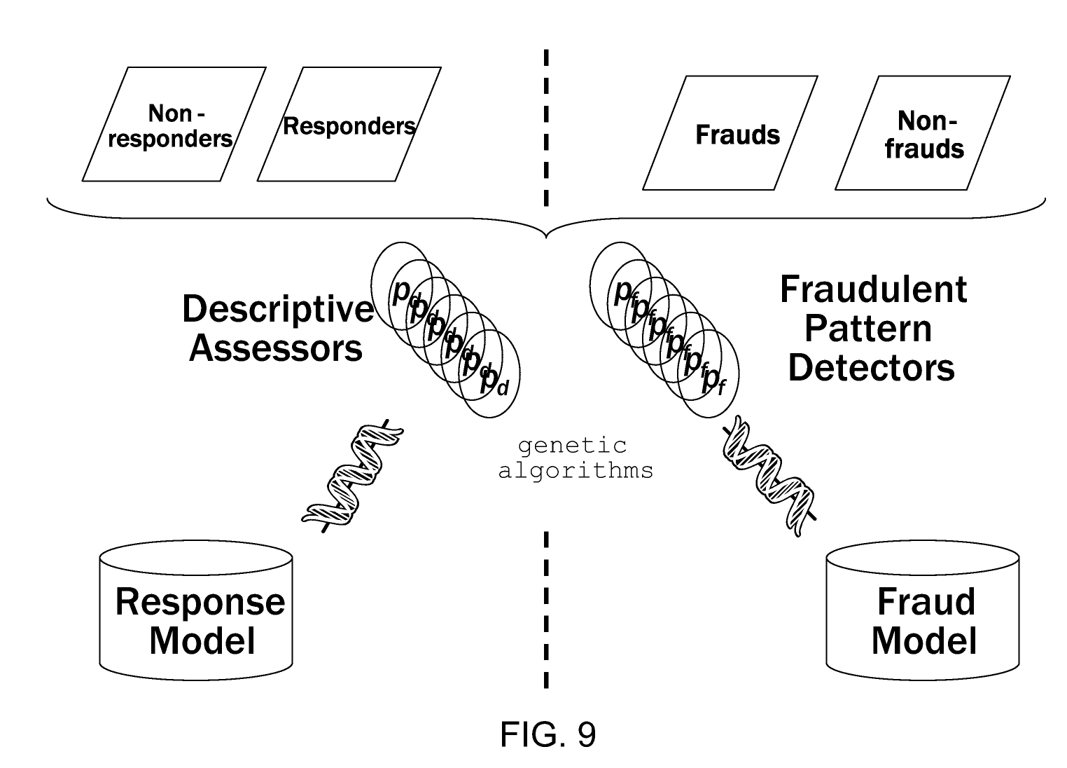

FIG. 9 illustrates another embodiment of a method 900 for detecting healthcare claim fraud and abuse, more particularly, a method of using a plurality of descriptive assessors and pattern descriptors to derive probabilistic response and fraud models. In some embodiments, the method 900 shows how two distinct models are created from two distinct populations (a response model 610 from responder/non-responder population and a fraud model 512 from fraud/non-fraud population). Though the populations and resulting models may be distinct, the same pool of features (descriptive assessors and fraudulent detectors) may be used to create both models, but the weights assigned and features selected may be different in both models.

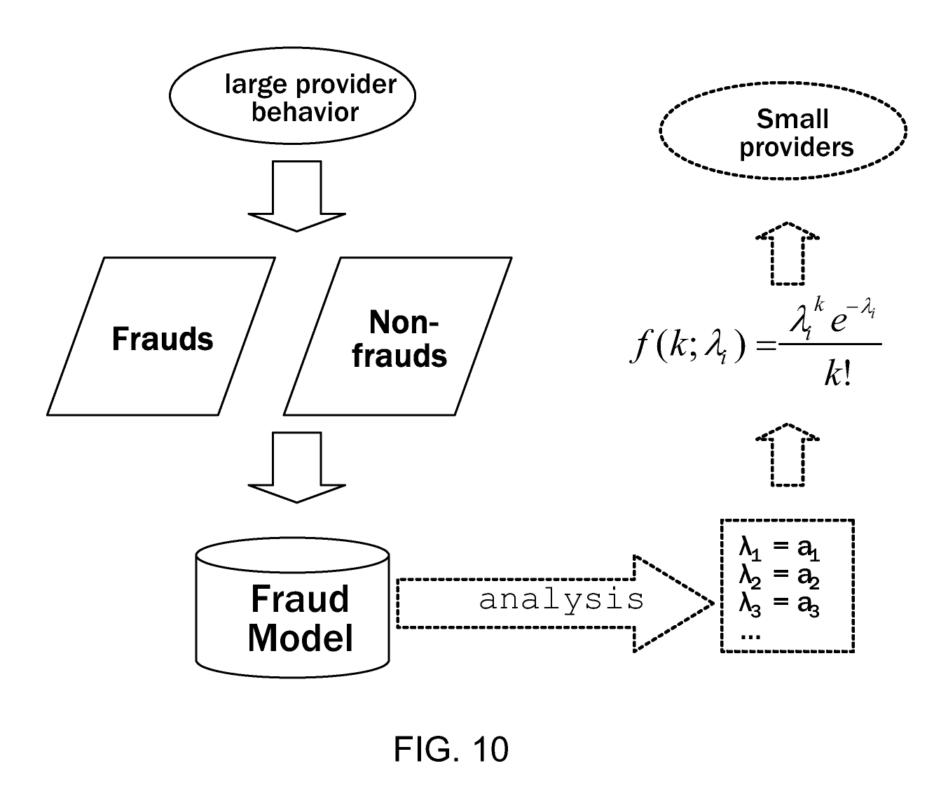

FIG. 10 illustrates another embodiment of a method 900 for detecting healthcare claim fraud and abuse, more particularly a method of statistic analysis of the fraud model for building an early detection probabilistic model system. The method 900 may be used to find anomalous providers who tend to recognize patterns in larger providers because the power of the method to detect fraud is directly related to the number of claims which embody the pattern. The method depicted ingests patterns from large providers such that a statistical parameter may be extracted from many large providers for use in a method that could identify fraudulent patterns in smaller providers. FIG. 10 also shows examples of the lamba parameter from a Poisson distribution being extracted and used to detect fraudulent patterns among smaller providers

FIG. 11 illustrates another embodiment of a method 900 for detecting healthcare claim fraud and abuse, more particularly, a method of combining response and fraud models to create the supervised model. The purpose of the supervised model 606 may be to create a score which ranks all claims in order of the probability of fraud. The fraud model 512 could effectively rank claims according to the probability of fraud within the population of responders. To use this model alone could ignore the fraud reported among non-responders. Similarly, the response model 610 could predict which of the claims, if stopped, would yield a response, irrespective of fraud content. The illustration in FIG. 11 shows how both models (which predict different outcomes) could be combined so that the supervised model 606 can jointly consider the probability of a response and probability of fraud, given a response.

All of the methods disclosed and claimed herein can be made and executed without undue experimentation in light of the present disclosure. While the systems and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for detecting fraud comprising:
detecting anomalous claims from a first group of insurance claims;
requesting records associated with the anomalous claims from service providers;
classifying the anomalous claims into responsive claims and non-responsive claims based on responsiveness of the service providers to the request, wherein fraudulent and non-fraudulent claims are identified from the responsive claims; and
generating a fraud model comprising a plurality of fraudulent pattern detectors based on the identified fraudulent and non-fraudulent claims.

2. The method of claim 1, further comprising generating a response model based on the classifying of responsive claims and non-responsive claims.

3. The method of claim 2, further comprising creating a supervised model for detecting fraud based on the response model and the fraud model.

4. The method of claim 1, further comprising assigning weight to the plurality of fraudulent pattern detectors.

5. The method of claim 4, further comprising selecting fraudulent pattern detectors, wherein the assigned weights of the selected fraudulent pattern detectors satisfy a predetermined criterion.

6. The method of claim 1, further comprising using fraudulent pattern detectors to detect anomalous claims from a second group of claims.

7. The method of claim 1, further comprising predicting the probability of fraud of at least a service provider.

8. The method of claim 1, further comprising predicting the probability of fraud of at least a claim.

9. A system comprising:
a data storage device configured to store a database comprising one or more claims;
a server in data communication with the data storage device, suitably programmed to:
detect anomalous claims from a first group of insurance claims;
request records associated with the anomalous claims from service providers;
classify the anomalous claims into responsive claims and non-responsive claims based on responsiveness of the service providers to the request, wherein fraudulent and non-fraudulent claims are identified from the responsive claims; and
generate a fraud model comprising a plurality of fraudulent pattern detectors based on the identified fraudulent and non-fraudulent claims.

10. The system of claim 9, wherein the server is suitably programmed to further generate a response model based on the classifying of responsive claims and non-responsive claims.

11. The system of claim 10, wherein the server is suitably programmed to further create a supervised model for detecting fraud based on the response model and the fraud model.

12. The system of claim 9, wherein the server is suitably programmed to further assign weight to the plurality of fraudulent pattern detectors.

13. The system of claim 12, wherein the server is suitably programmed to further select fraudulent pattern detectors, wherein the assigned weights of the selected fraudulent pattern detectors satisfy a predetermined criterion.

14. The system of claim 9, wherein the server is suitably programmed to further use fraudulent pattern detectors to detect anomalous claims from a second group of claims.

15. The system of claim 9, wherein the server is suitably programmed to further predict the probability of fraud of at least a service provider.

16. The system of claim 9, wherein the server is suitably programmed to further predict the probability of fraud of at least a claim.

17. A tangible computer program product comprising a computer readable medium having computer usable program code executable to perform operations comprising:
detecting anomalous claims from a first group of insurance claims;
requesting records associated with the anomalous claims from service providers;
classifying the anomalous claims into responsive claims and non-responsive claims based on responsiveness of the service providers to the request, wherein fraudulent and non-fraudulent claims are identified from the responsive claims; and
generating a fraud model comprising a plurality of fraudulent pattern detectors based on the identified fraudulent and non-fraudulent claims.

18. The tangible computer program product of claim 17, wherein the operations further comprise generating a response model based on the classifying of responsive claims and non-responsive claims.

19. The tangible computer program product of claim 18, wherein the operations further comprise creating a supervised model for detecting fraud based on the response model and the fraud model.

20. The tangible computer program product of claim 17, wherein the operations further comprise comprising assigning weight to the plurality of fraudulent pattern detectors.

21. The tangible computer program product of claim 20, wherein the operations further comprise selecting fraudulent pattern detectors, wherein the assigned weights of the selected fraudulent pattern detectors satisfy a predetermined criterion.

22. The tangible computer program product of claim 17, wherein the operations further comprise using fraudulent pattern detectors to detect anomalous claims from a second group of claims.

23. The tangible computer program product of claim 17, wherein the operations further comprise predicting the probability of fraud of at least a service provider.

24. The tangible computer program product of claim 17, wherein the operations further comprise predicting the probability of fraud of at least a claim.
